(19) United States
(12) Patent Application Publication
(10) Pub. No.: US 2025/0372064 A1
(43) Pub. Date: Dec. 4, 2025

(54) A MEASUREMENT SYSTEM AND A METHOD FOR DETERMINATION OF TIMBRE OF MUSICAL INSTRUMENTS

(71) Applicants: INNORENEW COE, IZOLA (SI); DANIEL SVENSEK, INTELEKTUALNE STORITVE IN SVETOVANJE, S. P., LJUBLJANA (SI)

(72) Inventors: Rok PRISLAN, SEMPETER (SI); Daniel SVENSEK, LJUBLJANA (SI); Ursa KRZIC, BOROVNICA (SI)

(21) Appl. No.: 18/714,335

(22) PCT Filed: Nov. 28, 2022
(86) PCT No.: PCT/SI2022/050032

§ 371 Date: May 29, 2024

(30) Foreign Application Priority Data
Nov. 29, 2021 (SI) P-202100210

(51) Int. Cl. G10H 1/00; H04R 1/40; H04R 3/00

(52) U.S. Cl. CPC G10H 1/0008; H04R 1/406; H04R 3/005; G10H 2210/056; G10H 2210/066; H04R 2201/401

(57) ABSTRACT

The present invention belongs to the field of acoustics and relates to a method for determination of timbre of musical instruments comprising the following steps:
selecting the musical instrument and tones to be analyzed,
playing the tones with the instrument and detecting the sound signals in a selected time window,
removing the initial (transient) and final (release) parts of the sound from the instrument sound/signal recorded in step b),
performing Fourier transform,
restriction to power, i.e., to the square of the absolute value of the amplitude,
determination of the fundamental frequency and the frequencies of the harmonics,
integration of the power in the frequency interval around each harmonic that corresponds to the width of the harmonic,
formation of a harmonic vector by frequency or amplitude weighting or ranking of the integrated harmonic powers, and
PCA or SVD analysis of the vectors formed in the previous step.

The result of steps h) and i) is a vector basis that most efficiently describes the statistical variations of the vectors, wherein the coordinates of a particular item are thus the projections of its harmonic vector onto these basis vectors.

### PRIOR RELATED APPLICATIONS

The present application is a National Entry of PCT Application No. PCT/SI2022/050032, filed on Nov. 28, 2022, which claims priority under the Paris Convention to Slovenian Application No. P-202100210, filed on Nov. 29, 2021. The entire contents of such prior applications are incorporated by reference herein.

### FIELD OF THE INVENTION

The invention belongs to the field of acoustics and, more particularly, to the field of devices and methods for analyzing the sound of musical instruments. The present invention relates to a method for determining the timbre of musical instruments and a measuring arrangement for precise quantification of timbre of musical instruments.

### BACKGROUND OF THE INVENTION AND THE TECHNICAL PROBLEM

A musical instrument is a device for performing music. They can be distinguished in a number of ways, but most often by the type of performance or sound production. Thus, we distinguish between strings, wind instruments, percussion instruments, brass instruments, plucked instruments, and keyboard instruments. Also important is the acoustic classification of musical instruments, which includes the following groups:
idiophones—self-sounding instruments,
metallophones—instrument in which metal sounds,
xylophones—instruments in which wood sounds,
chordophones—instruments that sound by the vibration of strings,
aerophones—instruments that function with the aid of air,
membranophones—instruments in which stretched membranes sound, and
electrophones—instruments that function with the aid of electricity or electronics.

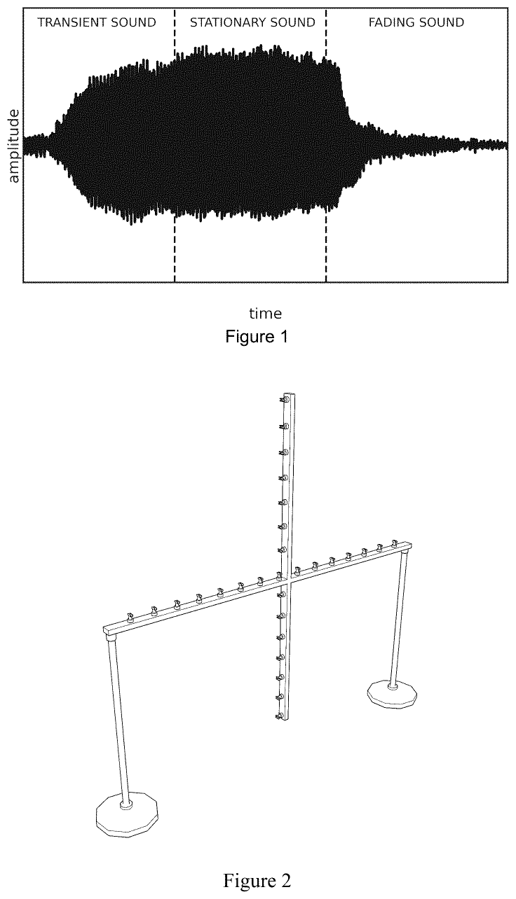

Most musical instruments belong to the class of pitched musical instruments, which can play individual tones. These are written as notes that have a specific pitch and duration. The sound produced by an instrument when playing a single note can be divided temporally into transient sound (attack, decay), stationary sound (sustain), and fading sound (release), as shown in FIG. 1. Pitch, intensity, and duration are therefore typical definable characteristics of the sound produced when playing pitched musical instruments, while timbre is a subjective characteristic on the basis of which no simple or one-dimensional scale can be established. From the point of view of the latter, not only does each musical instrument have its own sound or timbre, but they also differ individually, at the level of each instrument, except that the variations at this level are smaller. Timbre refers to an aspect among the basic characteristics attributed to a sound, that is, a characteristic in addition to pitch, intensity, and duration of the sound. Timbre is the quality of a sound that distinguishes it from all other sounds of the same pitch and intensity. The term comes from 19th century acoustics and suggests a certain similarity to the visual, where color has a similar function. It is a concept that encompasses a very complex acoustic reality. There are many adjectives and also psychoacoustic quantitative measures to describe the perception of timbre, such as “sharpness, roughness, brightness, thickness . . . ”, but these are crude and generic psychoacoustic qualifiers that by no means enable quantitative classification of instruments. Several aspects are important for the definition of timbre, both spectral (harmonic and anharmonic) and temporal (temporal modulations, transient phenomena). This invention deals with the spectral properties of sound, more specifically, its harmonic spectral properties. Any periodic oscillation (one that repeats strictly with a fundamental period corresponding to the fundamental frequency, e.g., pitch) may be composed of elementary (sinusoidal) oscillations (Fourier analysis) with frequencies that are exactly and exclusively multiples of the fundamental frequency (only in this way is the sum periodic). These elementary oscillations are called harmonics, and the spectrum of a periodic oscillation is harmonic—it consists only of harmonics.

Timbre is an important attribute of an individual musical instrument. At the same time, this aspect is also important for the purchase of musical instruments, their repair and maintenance. The problem is that with presently known methods it is not possible to measure, determine or otherwise specify the timbre, especially not to the extent that a quantitative comparison between individual musical instruments is possible. It is therefore the aim of the invention to quantify the timbre of stationary sound of a musical instrument within a family, so that such an analysis can be used for classification of the sound of musical instruments. Since the characteristics of the sound change significantly during the transient and fading phases, it is most useful to perform the analysis with the stationary part of the sound.

### STATE OF THE ART

Kitahara et al. (DOI: 10.1109/ICME.2003.1221335) describe a method to distinguish instruments (identification) based on the change of color with pitch. The method is suitable for distinguishing musical instruments, but not for defining their timbre or for classifying the sound of musical instruments.

Hourdin et al. (1997, https://www.jstor.org/stable/3681107) analyze instrument spectra based on recordings from different instruments. They take 4 ms long sections from the signals, limiting themselves to frequencies above 250 Hz and not considering the entire audible spectrum. From the frequency spectrum of the sections, 40 peak amplitudes and corresponding frequency values are extracted. The number of data is reduced using the method of factorial analysis of correspondences (FAC). The authors of the article do not measure the timbre of musical instruments, and their method does not allow robust comparison of musical instruments. Therefore, the results presented in this article are valid only for a selected set of recordings.

Burred et al. (https://hal.archives-ouvertes.fr/hal-01161413) roughly compare different instruments such as clarinet, piano, trumpet, violin, oboe with each other to distinguish between different musical instruments. The analysis is based on a time-spectral approach, wherein the amplitude of 20-40 peaks in the spectrum of a single tone is observed and PCA is performed. No measurement/recording method is specified in the description, which however has a significant impact on the input signals.

Patent application CN108615536A describes a method and a system for evaluating the sound quality of musical instruments, the system being based on a microphone arrangement, a hardware module and an evaluation module. Acoustic signals are captured by microphones when a musical instrument is played, and a neural network is then created or trained based on these signals, but the patent application does not reveal what this training is based on. Based on the latter, the system assesses the sound quality of musical instruments as it should be perceived by a human, which is significantly different from the present invention.

In her article “Using timbre changes in flute playing to enhance the perception of dynamics: A pilot study” (2020, Journées d'Informatique Musicale 2020—Préactes), Delisle uses 47 time-spectral sound descriptors with the aim of analyzing the variation of the factors with mode of playing (mainly with loudness). The problem with the method is its poor reproducibility, since the orientation of the musical instrument and microphones is not precisely specified or it is not ensured that at least minimal variations in the orientation or position of the musical instrument would not change the results.

De Paula et al. in the article “Timbre Representation of a Single Musical Instrument” analyze a single musical instrument at different volumes with a single microphone and track the temporal changes of the harmonics. The disadvantage of this method is poor reproducibility and instability, since there are variations due to loudness, and high measurement uncertainty due to the use of only one microphone.

All solutions differ from the present invention in that they do not allow robust numerical estimates or coordinates to be established separately for each musical instrument type, based on which the timbre of the musical instrument can then be evaluated, which in turn can be used to group musical instruments within the same musical instrument type according to their sound. In addition, solutions based on performing measurements (recording the sound of instruments) do not perform them in a way that ensures robustness and reproducibility.

### Description of the Solution to the Technical Problem

Timbre is a characteristic of a musical instrument that could not previously be measured with a quantitative and robust scale. The object of the invention solves the problem of calibrating or quantifying the timbre of musical instruments, the key being a suitable measurement setup and analysis method. The invention provides a multidimensional coordinate scale in a multidimensional timbre vector space that groups musical instruments within a type according to their timbre, the preferred solution of the method being to obtain at least three numerical values for each musical instrument, which can then be used as the basis for comparison between musical instruments and the resulting classification.

The measurement setup consists of a 2D assembly of at least one microphone, preferably at least 5 microphones, mounted on one or more stands, and an acquisition system. 2D assembly means that the stand or frame may have the shape of a rectangle or other planar or spherical figure in which or along the perimeter of which the microphones are arranged in the field, preferably in at least two points and/or orientations that are the same and/or different (e.g., vertical and horizontal or along two diagonals, two parallel verticals or two parallel horizontals). The number of microphones depends on the size of the instrument and the sounds to be analyzed (e.g., for a small instrument such as a violin, the analysis of low harmonics may be reliable enough with only one microphone, while for larger instruments the analysis with a larger number of microphones is more optimal), but can be adjusted as desired, which is obvious to a person skilled in the art. The system for capturing microphone signals can be further customized according to the requirements of the microphones used, which generally includes amplification, filtering, and analog-to-digital conversion. Captured signals in digital form are stored on a storage medium and subsequently processed by a computer (program), i.e. analyzed, or processed in real time.

During the measurement, the instrument is positioned with respect to the measurement setup as it is normally oriented when played with respect to the listener. Thus, the transverse flute is turned to the side while the measurement setup is in front of the musician. When measuring the strings, the measurement setup is also in front of the musician. Since musicians move while playing their instruments, it is desirable to create conditions that are as reproducible as possible. The solid angle averaging, which depends on the dimensions of the microphone array, must be such that it eliminates at least the inevitable variations that occur during normal, not overly gestural playing. In addition, the measurement setup must perform solid angle averaging of the musical instrument's radiation pattern. The specific characteristics of the measurement location or the acoustic response of the room in which the measurements are made must be either eliminated from the recording or taken into account as a standard or baseline. At the same time, the microphone field must be fine enough so that the angular averaging is adequate up to the frequencies of the highest harmonics that are included in the analysis—so that there is no physical aliasing in the acoustic field.

The measurement setup can be used to analyze any musical instrument that can produce tones with a sufficiently long stationary part. Most musical instruments belong to the class of pitched instruments, which are capable of playing individual tones that are notated as notes with specific pitch and duration. The sound produced by the instrument when a note is played can be divided temporally into a transient sound (attack, decay), a stationary sound (sustain), and a fading sound (release), as shown in FIG. 1. Since the characteristics of the sound change significantly in the transient and fading phases, only the stationary phase is used in the analysis with the measurement setup and method according to the invention. The method according to the invention is therefore most suitable for musical instruments with sustained, driven sound, such as strings, brass, woodwinds, and somewhat less suitable for e.g. plucked instruments, piano, percussion, which have an impulsive sound whose transient phase has a much greater importance for the timbre of the instrument and is therefore less meaningful to exclude. It is important that the musician plays the instrument as he normally plays it, but without special variations such as the use of vibrato, articulation changes or ornamentation, extremely soft (piano) or loud (forte) playing. If a timbre analysis of piano or forte playing or any other repeatable playing style is desired, the entire analysis can be performed in the same manner as described above, except that during the measurement with the measurement setup the instrument is now played either piano or forte or in some other selected playing style to produce a new combination of instrument coordinates. The difference between forte and piano coordinates can, of course, also significantly characterize a musical instrument.

Measurements with the measurement setup according to the invention can be carried out in different rooms, either in a free sound field (in the open air or in an anechoic chamber) or in a diffuse sound environment (in a reverberation chamber) or in a sufficiently large room, which represents a kind of real field and is usually a concert hall or a similar venue.

From the point of view of the above-mentioned solid angle averaging and the best possible sound detection, there is in principle no upper limit to the number of microphones, the number of channels, and the amount of data collected, but the implementation with a full two-dimensional microphone array is suboptimal because too many channels are needed, which would make it difficult to determine the timbre of musical instruments. Therefore, the preferred implementation of the measurement setup is a microphone array in the form of a cross or the letter X, which, with the practical limitations mentioned above, satisfies both size and fineness requirements and, as has been empirically demonstrated, provides robust results.

For the measurement in the free field, the measurement setup for quantifying the timbre according to the first embodiment consists of at least a sufficient number of microphones (microphone array), e.g., at least 5, preferably 10 or more microphones, arranged in the characteristic direction and listening distance of the musical instrument, which is typically in the range of 1 to 10 m. For the selected position of the microphone array from the instrument, the differences in the distances to the microphones are small, which limits the volume variations between the individual microphones. The distances between the microphones are preferably between 1 cm and 30 cm, preferably between 5 and 25 cm, usually 7 cm. The number and arrangement as well as the distances between the microphones in the measurement array can be adjusted according to the size of the musical instrument and the analyzed tone. The microphones used in the measurement array have identical characteristics. The size of the microphone array is chosen to i) cover a reasonable solid angle of sound radiation and thus define a meaningful standard and ii) ensure robustness and reproducibility by solid angle averaging.

For measurements in a sufficiently diffuse field, the measurement setup for quantifying the timbre according to the second embodiment consists of at least a sufficient number of microphones, for example at least 5, preferably 10 or more microphones, freely distributed in the room so as to cover distances comparable to the longest relevant wavelength of the sound, which allows spatial averaging of the detected signals according to the statistical requirements for a diffuse sound field. The microphones must be placed in the room in such a way that the contribution of direct sound and early sound reflections from the boundary surfaces of the room is negligible. In this case, the distance to the musical instrument is not important and can be arbitrary, and the microphone array can also be different from the implementation for a free field, wherein the microphone array used is preferably arranged in the shape of a cross or the letter X. The microphones used in the measurement array have identical characteristics.

In addition to free and diffuse field measurements, measurements can also be performed in acoustic conditions/rooms where the instrument is typically used, such as concert halls, chamber halls, and rehearsal rooms. These rooms are also the most realistic for the application of the method, which is why this implementation is preferred. In such a case, there is a direct sound, pronounced first sound reflections and later sound reflections. Thus, the measurement setup for quantifying timbre according to the third embodiment consists of at least a sufficient number of microphones (microphone array) arranged in the characteristic direction and listening distance of the musical instrument, which is typically in the range of 1 to 10 meters. In this case, the differences in the distances to the microphones are small, which limits the volume variations between the individual microphones.

With such an arrangement of microphones, we can evaluate the direct sound and the sound of the first reflections equally for all measured instruments. The latter is usually strongest from the floor and can be greatly reduced by placing absorbing materials at key locations from which significant geometric reflections emanate. The acoustic response of the room, which is determined by the later sound reflections, must be sufficiently diffuse. In this case, regardless of the selected measurement position in the room, based on a sufficient number of microphones, spatial averaging of the acquired signals can be performed according to the statistical requirements for a diffuse sound field. The microphones used in the measurement array have identical characteristics.

The entire setup and the room in which it is placed must meet the conditions of a free, diffuse or characteristic acoustic environment. In this way, at least the natural movements of the instrument during playing are neutralized, making the result robust and reproducible.

An important group of musical instruments are also electric/electronic instruments or electrophones, in which the sound is produced directly in the form of an electric (digital or analogue) signal that is generally amplified and reproduced through a speaker system for listening. An important feature of such instruments is that the generated sound in the form of a signal does not need to be captured from the sound field with the help of microphones, but is generated directly on the instrument. Acoustic musical instruments with an additional sound pickup system have a similar function, wherein microphones, piezo transducers or other pickup systems are attached directly to the musical instrument that is the sound source. The pickup system is used to record musical instruments and increase the volume through a speaker system.

For instruments with the additional sound pickup system, the electrical (digital or analogue) signal is generated directly on the instrument and does not need to be captured from the sound field using microphones. The quantification method according to the invention is applied directly to the electrical signal available at the musical instrument.

For each group of musical instruments, based on their characteristics of sound production and range, at least one, and preferably several, characteristic tones are selected, which may be arbitrary, but must be consistent when analyzing the same group of musical instruments. For strings, for example, this may be four open strings. It is desirable to select at least three tones or measurement points, but there may be more (depending on the characteristics of the musical instrument being analyzed), preferably in different octaves or in the lower part of the range, the middle part of the range, and the upper part of the range.

The musician then plays the selected tones, each one separately, and uniform sound samples are recorded with stationary parts that are at least half a tenth of a second long, preferably at least half a second long or longer, which allows for i) frequency precision (fine frequency structure) and ii) robustness, since time averaging of random fluctuations is sufficient (stationarity is not perfectly ideal in reality). Non-stationarity is also contributed by the response of the room, which settles on the characteristic time scale of the reverberation time of the room after the stationary part of the sound of the musical instrument sets in—this transient phenomenon must also be avoided. In this way, the sound is as stationary as possible (constant, non-modulated tone of the instrument), which ensures the necessary accuracy and repeatability. By definition, stationary sound consists of exact multiples of the fundamental frequency (i.e. harmonics, overtones, i.e. sinusoidal oscillations with frequencies that are multiples of the fundamental frequency). Its timbre is given by the differences of the logarithms of their strengths, i.e. by the harmonic spectrum. Briefly explained, it is obtained by removing the initial parts of the sound (transient sound) and the final parts of the sound (fading sound) from the recorded sound of the instrument, then performing a Fourier transformation and carrying out the following steps:
determination of the fundamental frequency and the frequencies of the harmonics
restriction to power, i.e., to the square of the absolute value of the amplitude
integration of the power in a selected frequency interval around each harmonic
formation of a harmonic vector by frequency or amplitude weighting or ranking of the integrated harmonic powers, preferably by logarithms of the integrated harmonic powers, and
PCA or SVD analysis of the vectors formed in the previous step.

The measurement of each tone is preferably repeated at least twice, more preferably five times. The repetitions serve two purposes: they additionally contribute to averaging (especially in cases where the tone build-up from the initial transient varies slightly from one trial to another), but most importantly, they provide a standard deviation that defines a natural tolerance of the method.

A certain number of the detected harmonics of the acquired sample is chosen, wherein this number can be optimally determined only on the basis of a sufficiently large statistical sample of instruments of a given type and varies from type to type. Higher harmonics are typically weaker, less well defined, less stable, more variable in time, and also change from trial to trial. The number of harmonics is chosen so that the results, i.e. the coordinates, are statistically as well defined as possible. Therefore, it makes sense to perform this step only at the end and to decide for each tone how many of its harmonics should be included in the coordinate standard.

In the case of the violoncello, the number of relevant, characteristic harmonics is up to around 30 for the lowest (C) string. So many amplitudes represent far too large an amount of data to be robustly determined and thus actually useful. Therefore, we proceed as follows. As many cellos as possible are analyzed. Their harmonic spectra are considered as vectors (e.g., a vector with 30 components) and are transformed with PCA (principal component analysis) or SVD (singular value decomposition) method. In this way, a hierarchical basis is created in this vector space that most efficiently describes the statistical variations between the instruments. Thus, the features that enter the PCA method are the harmonics of the periodic signal in a constant time window of sufficient length, which brings the accuracy and robustness needed to form reliable coordinates. It turns out that the first (=most important) few basis spectra (in this case 2 or 3) characterize all included celli very well. The projections of the harmonic spectra onto these basis vectors are the introduced timbre coordinates. The coordinates or the corresponding basis spectra, whose presence is specified by these coordinates, have a direct meaning of harmonic timbre, therefore:
i. they can be listened to and then, if desired, labelled according to their auditory perception (such labelling belongs to the field of psychoacoustics) or according to characteristic representatives (e.g., ideals), which is made possible by the property of the method highlighted in point ii. as follows,
ii. they are not just a more or less random fingerprint of a musical instrument, wherein even very similar instruments are strongly separated. Instead, the coordinates allow for an auditory relevant grouping of related instruments into meaningful clusters, that can also tell us something about the instrument, such as the origin of wood, the technique of manufacture, and the like. In other words, timbre coordinates also introduce a timbre metrics (a definition of distance in timbre space) according to which tones with similar timbres are placed close together and tones with less similar timbres are placed further apart.

The method according to the invention thus comprises the following steps:
a) selection of musical instruments and tones to be analyzed, and optionally playing style, if analysis of piano playing, forte playing, or any other repeatable playing style is desired, including as many items of the selected instrument type as possible to obtain a sufficiently representative collection of samples for the selected instrument type,
b) playing the tones selected in step a) with the instrument and detecting the sound signals by the measurement setup described above or the sound signal generated directly on the instrument, in a single time window of at least half a tenth of a second, preferably at least one tenth of a second, most preferably at least one second, wherein it is also desirable to pay attention to environmental conditions in the measuring room, especially in the case of wooden instruments, monitoring or controlling air humidity, while the temperature is normally at a room temperature around 25 degrees Celsius, wherein the playing of the selected tones can be repeated, preferably five times,
c) the initial (transient) and final (release) parts of the sound are removed from the instrument sound/signal recorded in step b),
d) Fourier transform is performed, preferably with a window function that reduces the broadening of the spectral peaks due to the finite time window of the signal,
e) restriction to power, i.e., to the square of the absolute value of the amplitude,
f) determination of the fundamental frequency and the frequencies of the harmonics,
g) integration of the power in the frequency interval around each harmonic that corresponds to the width of the harmonic,
h) formation of a harmonic vector by frequency or amplitude weighting or ranking of the integrated harmonic powers, preferably by logarithms of the integrated harmonic powers, and
i) PCA or SVD analysis of the vectors formed in the previous step.

The harmonic vectors of all acquired instrument samples are stacked into a matrix, which is transformed with the PCA or SVD method. The result is a vector basis that most efficiently describes the statistical variations of the vectors and is hierarchically order by importance—when expanding over these basis vectors, the first basis vectors is given the largest weight (the first factor), followed by the second basis vector, which is weighted by the second, smaller factor, and so on. The first few basis vectors, usually two, three, or four, are suitable for defining the timbre coordinates of the analyzed musical instrument type. The coordinates of a particular item are thus the projections of its harmonic vector onto these basis vectors.

The method of quantification is carried out separately for each family (strings, woodwinds, brass, . . . ) and subfamily (violins, violas, violoncelli, double basses, flutes, oboes, clarinets, . . . ) of musical instruments, taking into account the specifics of the instruments, which results in the definition of coordinates of individual subfamilies of instruments, on the basis of which also other items belonging to a chosen family can be compared. Once such a spectral landscape of an instrument type is established, the timbre of instruments of this type can be specified simply with a set of numbers, i.e. coordinates. These can be used to distinguish between instruments (which is also relevant for tracking changes in individual instruments over time), but most important, they serve as quantifiers of the sound characteristic—items with similar coordinates will sound similar (e.g., which items will sound similar to a famous Stradivari or Guarneri exemplar—if it was measured). The method for determining the timbre of an instrument suitable for producing a tone with a sufficiently long stationary part, in the case where the harmonic vector space basis for this instrument type has already been established by the method described above, comprises the following steps:
a) selection of musical instrument and of at least one tone to be analyzed, and optionally playing style, if the analysis of piano playing, forte playing, or any other repeatable playing style is desired,
b) playing the tones selected in step a) with the instrument and detecting the sound signals by the measurement setup described above in a single time window of at least half a tenth of a second, preferably at least one tenth of a second, most preferably at least one second, wherein the playing of the selected tones can be repeated, preferably five times,
c) the initial (transient) and final (release) parts of the sound are removed from the instrument sound/signal recorded in step b),
d) Fourier transformation is performed, preferably with a window function that reduces the broadening of the spectral peaks due to the finite time window of the signal,
e) restriction to power, i.e., to the square of the absolute value of the amplitude,
f) determination of the fundamental frequency and the frequencies of the harmonics,
g) integration of the power in the frequency interval around each harmonic that corresponds to the width of the harmonic,
h) formation of a harmonic vector by frequency or amplitude weighting or ranking of the integrated harmonic powers, preferably by logarithms of the integrated harmonic powers, and
i) projecting the harmonic vector formed in the previous step onto the predefined harmonic vector space basis.

The described method for determining the timbre of an instrument can be performed by an appropriately coded computer program or a computer with this program.

The invention described above can be used for labelling musical instruments, for comparing musical instruments, in music production, as well as in marketing and production of musical instruments, for listening tests of instruments without actually playing them, for example, when purchasing musical instruments online. The invention can also be used to detect instrument damage or counterfeiting, as a guide for repairing and fine-tuning instruments, and as a virtual tool for sound engineers/designers in the studio. A possible application of the method for instruments with an additional pickup system is also precise and reproducible positioning of the pickup microphone to the instrument. Furthermore, a comparison with the timbre of the acoustic sound of the same instrument or another ideal instrument quantified with the measurement setup and method according to the invention allows an optimal positioning of the pickup microphone.

In developing the present invention, it was also found that other sound sources producing a sufficiently stationary sound can be classified in the same manner as musical instruments, with the steps of the method of the invention being adapted accordingly with respect to the sound source, which is obvious to a person skilled in the art from of the above description. For example, the sounds of various machines, vehicles, household appliances, etc. can be included in the analysis. In the case of washing machines, a sound analysis could be performed during different washing, tumble-drying or drying programs and the machines could be classified into groups using the method described above.

The measurement setup and method for determination of timbre of musical instruments according to the invention are described in more detail below based on embodiments and figures that show:

FIG. 1 Schematic representation of the sound waveform of a single tone

FIG. 2 Example of the microphone stand with the microphone array for measuring a musical instrument in a characteristic acoustic field

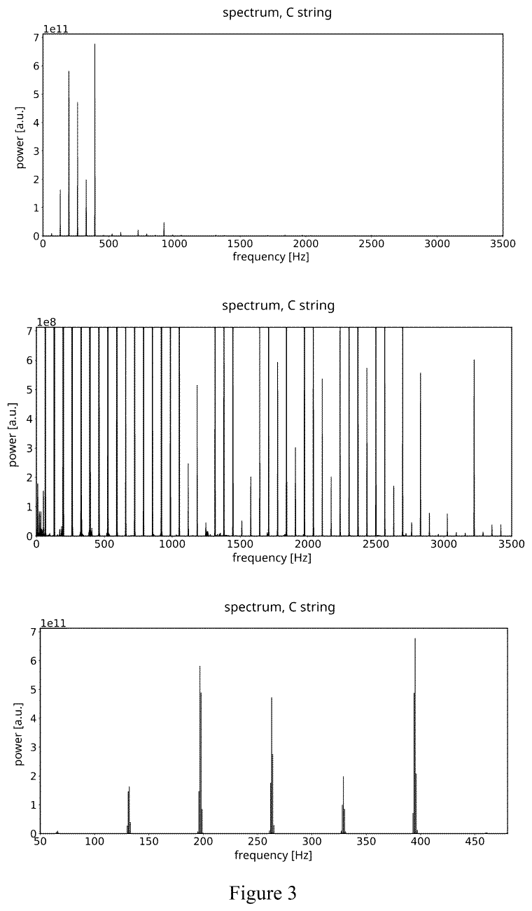

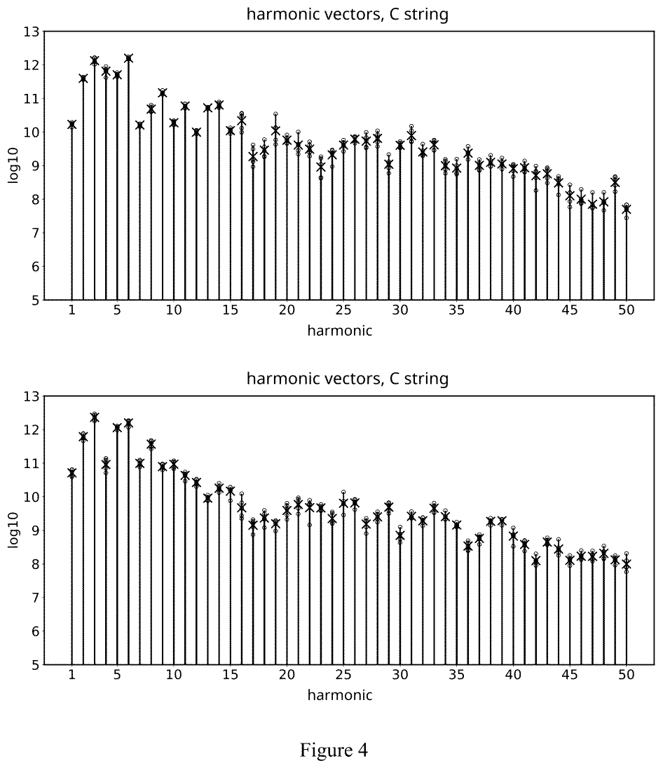

FIG. 3 Example of a power spectrum of the tone C (fundamental frequency approx. 65.8 Hz) (top), vertical axis with 1000-fold magnification (middle), first 7 harmonics in detail (bottom)

FIG. 4 Examples of harmonic vectors of two instruments for 5 consecutive measurements (circles) and their average in log space (crosses)

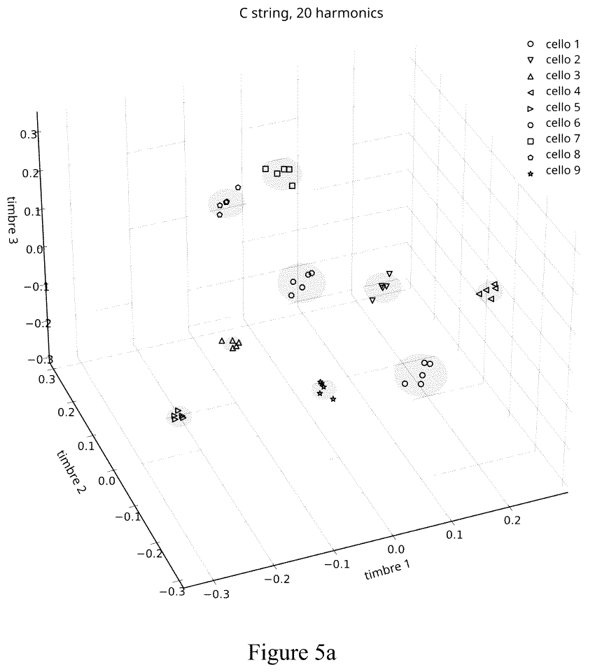

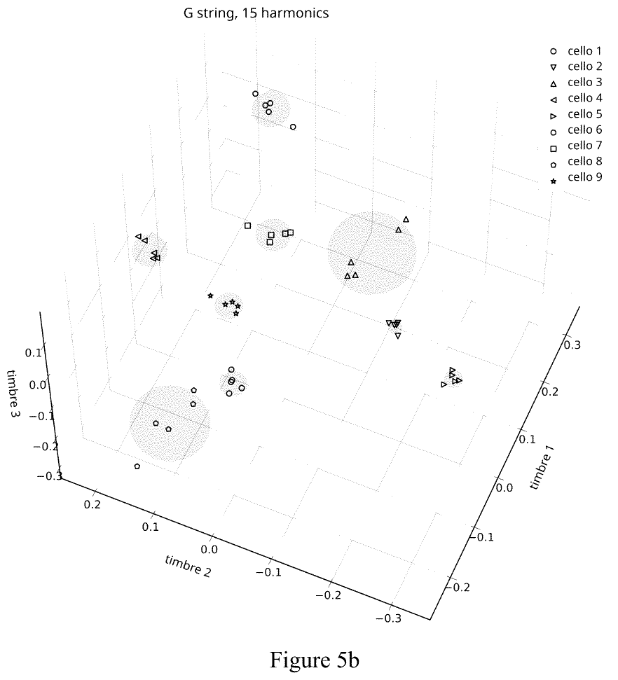

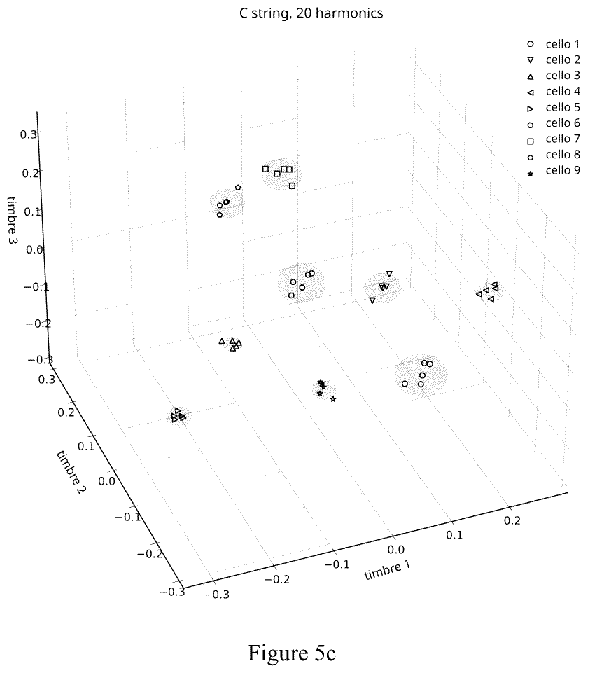

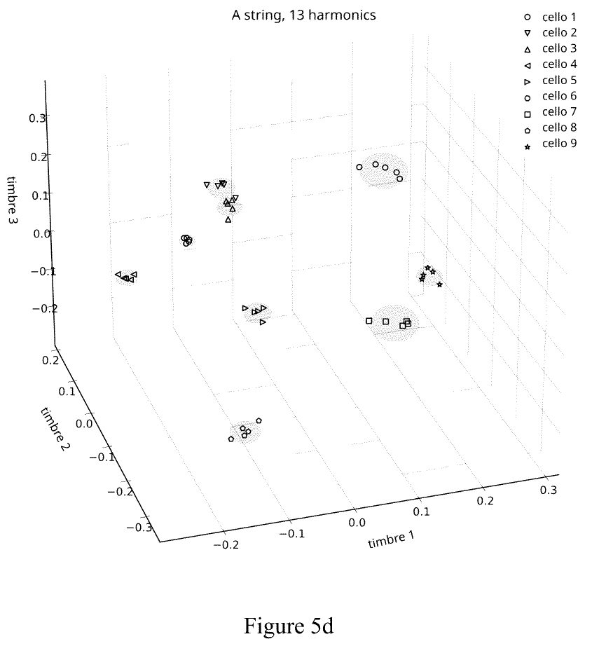

FIG. 5 Example of the results of the analysis of nine violoncelli using the method according to the invention

The measurement setup and method for quantification of timbre can be applied to any musical instrument mentioned above that can produce a tone with sufficiently long stationary part having a duration of at least half a tenth of a second, preferably at least one tenth of a second, more preferably at least half a second or more. The method according to the invention is particularly suitable for strings, brass and woodwind instruments, whereby it is possible to compare individual types of musical instruments, individual musical instruments or the same musical instrument at different times, playing styles, instrumentalists, tunings, and other conditions. Musical instruments are evaluated based on the coordinates determined using the described measurement setup and method of the invention by comparing the determined coordinates and grouping the musical instruments into clusters within the same musical instrument family, so that it can be determined which musical instrument is similar to which or whether the timbre changes over time. The embodiment of the measurement setup and method for determining the timbre of musical instruments was adapted for the analysis of strings.

Strings play individual tones, noted as notes with specific pitch and duration. The sound produced by the instrument when a single note is played can be divided in time into transient sound, stationary sound and fading sound, as shown in FIG. 1.

The measurement setup used for the analysis of strings is shown in FIG. 2 and consists of microphones mounted on a cross-shaped stand and an acquisition system. The measurement array consists of a vertical support with 14 microphones and a horizontal support with 15 microphones. All microphones have identical characteristics. The distance between the microphones is 7 cm. The measurement array was placed at the usual listening distance to the musical instrument, which is typically in the range of 1 to 10 m: in the measurements, the distance from the centre of the resonating plate of the cello was 120 cm. The microphone signals are processed by the acquisition system according to the requirements of the microphones used, which generally includes amplification, filtering, and analog-to-digital conversion. The acquired signals in digital form are stored on a storage medium and then processed by a computer (program), i.e. analyzed, which can also be done in real time.

The measurements with the measurement setup according to the embodiment were performed in a characteristic acoustic field. Example of the results of the analysis of nine violoncelli using the method of to the invention, performed as follows:
a) selection of the violoncelli to be analyzed and the notes to be analyzed, which were the four open strings at normal playing (e.g. not piano or forte),
b) playing the tones selected in step a) with the musical instrument with the inactive strings damped and recording the signals with the measurement system described above in a time window of one second, the measurements being performed at room temperature,
c) the initial (transient) and final (release) parts of the sound were removed from the instrument sound/signal recorded in step b),
d) Fourier transformation was performed,
e) restriction to power, i.e., to the square of the absolute value of the amplitude,
f) fundamental frequencies and the frequencies of the harmonics were determined,
g) integration of the power in the frequency interval around each harmonic that corresponds to the width of the harmonic,
h) formation of a harmonic vector of logarithms of the integrated harmonic powers, and
i) PCA or SVD analysis of the vectors formed in the previous step.

The harmonic vectors of all instrument samples are stacked into a matrix, which is transformed with the PCA or SVD method. The result is a vector basis of these harmonic vectors that most efficiently describes the statistical variations of the vectors and is hierarchically order by importance—when expanding over these basis vectors, the first basis vectors is given the largest weight (the first factor), followed by the second basis vector, which is weighted by the second, smaller factor, and so on.

The first few basis vectors, usually two, three, or four, are suitable for defining the timbre coordinates of the analyzed musical instrument type. The coordinates of a particular item are thus the projections of its harmonic vector onto these basis vectors. The first basis vector represents only the loudness, the next three basis vectors were used to define the timbre coordinates of the analyzed instruments, as shown in FIG. 5.

Sampling was done with 24 bits and a frequency of 65536 Hz. One-second samples of the most stationary parts of the instrument sound were analyzed, that is the signals x(tⱼ) of all microphones individually. The whole described analysis is performed separately for each of the four strings of the instrument. Fast Fourier transform (FFT) of the signals was performed, with one of the normalized standard time window functions w(tⱼ), e.g. Blackmann-Harris, x(fₖ)=FFT[x(tⱼ)w(tⱼ)]. The spectral power was calculated, i.e. the square of the absolute value of the FFT transform, |x(fₖ)|².

FIG. 3 shows an example of the power spectrum of the tone C (fundamental frequency approx. 65.8 Hz) (top), vertical axis with 1000-fold magnification (middle), and first 7 harmonics in detail (bottom).

The accurate fundamental frequency of the tone and the accurate frequencies of the harmonics, which of course generally do not fall on the FFT grid, are determined by first locating power peaks with sufficient prominence and a prescribed minimum spacing using a peak-finding method that should be familiar to an expert in the field. A histogram of the frequency differences of adjacent peaks is then constructed and the exact position of its maximum is determined by interpolation. This corresponds to the fundamental frequency of the sound and its multiples correspond to the harmonics, which are then placed on the nearest points of the FFT grid. Instead of the mentioned histogram of the frequency differences of adjacent peaks and interpolation, the procedure for determining the harmonic frequencies can also be carried out in any other way known to a person skilled in the art.

What follows is the summation of the powers in a suitable frequency neighbourhood k around each harmonic i to the total power of this harmonic Pᵢ=Σₖ|x(fᵢ₊ₖ)|². The width of the summation neighbourhood depends on the width of the harmonics, which depends on several factors, on the natural width characteristic of the type of instrument, on the degree of sound stationarity, on the length of the analyzed signal . . . The width is chosen empirically so that the results depend as little as possible on this choice, in our case the relative width is 0.02.

The powers Pᵢ of the harmonics are components of a multidimensional »spectral« vector P that exists for each microphone channel. The vectors P are arithmetically averaged over all (in this case 33) channels to obtain a single spectral vector P̅ for each measurement.

The obtained harmonic power spectra are logarithmized, hᵢ=log₁₀P̅ᵢ̅. The logarithms hᵢ, representing the loudness of the harmonics, are components of a multidimensional »harmonic« vector h; its dimensionality depends on the chosen number of harmonics. Instead of log₁₀ one could also use a logarithm with arbitrary base or also e.g. 10 log₁₀ as in the decibel (dB) scale and the like, but this has no influence on the performance of the method and on the values of the generated coordinates, and only scales the importance factors (which are defined further below). Examples of harmonic vectors of two instruments are shown in FIG. 4, where the circles represent 5 consecutive measurements and the crosses represent their average in log space. The harmonic vectors h are determined for each instrument, with each measurement repeated several times, 5 times in in the example described. Thus, 5 harmonic vectors h^{j} are assigned to the string of each instrument. The definition of these vectors was a preparatory step for the main part of the analysis, which from now on will be performed exclusively on the harmonic vectors h^{j}. The harmonic vectors of all instruments are stacked as columns in the matrix Aᵢⱼ. Thus, the second index represents the harmonic vectors and the first index represents their components. Let us assume that the matrix is wide, i.e. has more columns than rows, which is the usual situation. The matrix is decomposed with the SVD (singular value decomposition),

$$A = U S {V}^{T} , {A}_{ij} = {\sum }_{k} {U}_{ik} {S}_{k} {V}_{kj}^{T}$$

where U is a square matrix of the size of the harmonic vector, S=diag(Sₖ) is a diagonal matrix of the same size with nonnegative values Sₖ ordered from largest to smallest, and V^{T} is a wide matrix of the same height and with width equal to the number of harmonic vectors.

The SVD decomposition finds such mutually orthogonal linear combinations in the space of harmonic vectors h^{j} that best describe the variations of harmonic vectors in the entire sample collection. These are the harmonic basis vectors, i.e., the timbre »factors«, Column k of the Uᵢₖ matrix is the harmonic representation of the k-th timbre factor, and Sₖ is the factor of its importance in the expansion of any harmonic vector from the collection over the timbre factor basis. The matrix U is orthogonal. The columns of the matrix

$${V}_{kj}^{T}$$

are representations of the harmonic vectors j in the basis of the timbre factors and the rows are representations of these factors in the canonical basis of the harmonic vectors of the collection (in this basis, the first harmonic vector of the collection is (1, 0, 0, 0, . . . ) and so on). The rows of the wide V^{T} matrix are orthonormal, while the columns are orthogonal only as completely as possible, but not completely orthogonal, with norms generally less than 1.

A sample j of the collection is written as

$${h}_{i}^{j} = {A}_{ij} = {U}_{i 0} {S}_{0} {V}_{0 j}^{T} + {U}_{i 1} {S}_{1} {V}_{1 j}^{T} + {U}_{i 2} {S}_{2} {V}_{2 j}^{T} + {U}_{i 3} {S}_{3} {V}_{3 j}^{T} +$$

The timbre coordinates assigned to a sample of the collection are the components of the corresponding column of the V^{T} matrix. For example, the first four coordinates of the j-th sample are the numbers

$${V}_{0 j}^{T} , {V}_{1 j}^{T} , {V}_{2 j}^{T} and {V}_{3 j}^{T} .$$

One must be careful that the chosen timbre coordinates do not depend on the loudness of the sample. One could achieve this by pre-normalising all samples to a standard power, but this would introduce that standard power as part of the definition of the coordinates, which is not good. The easiest way to avoid this is to use a practical trick, making sure that the hᵢ^{j} (note that they are logarithms) have sufficiently large values. These depend on the choice of units for the signal amplitude and can be safely increased by an arbitrarily large constant h⁰ which is only a scaling, i.e. only a change of the volume or its units. In this way, the hᵢ^{j} no longer vary in an interval of few B (bels) around a small value, but in the equally small interval around the arbitrary large value. Consequently, among the basis vectors of the SVD decomposition of the vector collection h⁰+h^{j}, where h⁰ is a vector with all components identical and |h⁰|>>|h^{j}|, there is now a basis vector with all components practically identical; since |h⁰|>>|h^{j}|, this is the largest, zeroth factor. This factor represents practically only the loudness. The desired consequence is that thus all other basic factors supplied by the SVD are practically perfectly orthogonal to the loudness vector. This means, however, that a change in the loudness will affect only the zeroth coordinate, while leaving all other coordinates untouched. Thus, the timbre coordinates of the j-th sample are

$$( {c}_{1}^{j} , {c}_{2}^{j} , {c}_{3}^{j} , … ) = ( {V}_{1 j}^{T} , {V}_{2 j}^{T} , {V}_{3 j}^{T} , … )$$

and depend neither on the scaling of the loudness nor on the choice of its units.

The timbre coordinates (c₁, c₂, c₃, . . . ) can just as well be assigned to a harmonic vector g of a sample that was not included in the A matrix and therefore did not participate in the definition of the basis vectors of the timbre space. In this case, the harmonic vector is projected onto the representations of the basis vectors:

$${c}^{j} = \frac{1}{{S}_{j}} {\sum }_{i} {U}_{ij} {g}_{i}$$

Hence, the coordinates are

$$( {c}_{1} , {c}_{2} , {c}_{3} , … ) = ( \frac{1}{{S}_{1}} {\sum }_{i} {U}_{i 1} {g}_{i} , \frac{1}{{S}_{2}} {\sum }_{i} {U}_{i 2} {g}_{i} , \frac{1}{{S}_{3}} {\sum }_{i} {U}_{i 3} {g}_{i} , … )$$

Examples will be shown for the definition of the timbre space and the determination of the timbre coordinates (c₁, c₂, c₃, . . . ) of all four open strings of nine violoncelli according to the described method.

FIG. 5 shows the results of the analysis of nine violoncelli, i.e., their strings C (FIG. 5a), G (FIG. 5b), D (FIG. 5c), and A (FIG. 5d). The numerical values of the coordinates are given in the tables below. It can be seen from the figures and tables that the timbres of all cellos differ on all strings, so that their measurements form clusters. Nevertheless, based on the coordinates of the A string, for example, it is possible to conclude that the cellos 2 and 3 sound similar because their coordinates (−0.035, 0.155, 0.100) and (−0.035, 0.116, 0.079) are similar. On the same string, the cellos 1 and 8 sound very different, as shown by the large differences between the coordinates (0.131, −0.116, 0.308) and (−0.147, −0.309, −0.122). In the same way, musical instruments can be compared with each other, or the same instrument can be analyzed in the same way at regular intervals to detect changes in sound. This type of measurement is also useful in the repair or maintenance of musical instruments.

The importance factor Sₖ is a measure of importance, that is, of the influence of the corresponding coordinate, used to determine the most important and reproducible coordinates for distinguishing musical instruments. The differences between instruments are greatest in the “direction” quantified by the first coordinate.

TABLE 1
coordinates of the C strings of the cellos

| importance | coordinate 1 | coordinate 2 | coordinate 3 | |
|---|---|---|---|---|
| factor: | 5.69 | 4.69 | 4.29 | std. deviation |
| cello 1 | 0.078 | −0.237 | 0.005 | 0.021 |
| cello 2 | 0.129 | 0.028 | −0.0186 | 0.015 |
| cello 3 | −0.158 | −0.042 | −0.007 | 0.008 |
| cello 4 | 0.238 | −0.139 | 0.078 | 0.011 |
| cello 5 | −0.287 | −0.143 | −0.058 | 0.010 |
| cello 6 | 0.073 | 0.238 | −0.167 | 0.021 |
| cello 7 | −0.022 | 0.088 | 0.276 | 0.016 |
| cello 8 | −0.079 | 0.188 | 0.139 | 0.016 |
| cello 9 | 0.024 | 0.022 | −0.251 | 0.010 |

TABLE 2
coordinates of the G strings of the cellos

| importance | coordinate 1 | coordinate 2 | coordinate 3 | |
|---|---|---|---|---|
| factor: | 5.84 | 3.75 | 3.69 | std. deviation |
| cello 1 | −0.147 | 0.019 | −0.060 | 0.011 |
| cello 2 | 0.175 | −0.117 | −0.285 | 0.006 |
| cello 3 | 0.074 | −0.115 | 0.097 | 0.034 |
| cello 4 | −0.058 | 0.192 | 0.096 | 0.014 |
| cello 5 | −0.083 | −0.309 | 0.088 | 0.008 |
| cello 6 | 0.290 | 0.145 | 0.058 | 0.016 |
| cello 7 | 0.037 | 0.031 | 0.112 | 0.014 |
| cello 8 | −0.166 | 0.122 | −0.236 | 0.032 |
| cello 9 | −0.117 | 0.036 | 0.124 | 0.011 |

TABLE 3
coordinates of the D strings of the cellos

| importance | coordinate 1 | coordinate 2 | coordinate 3 | |
|---|---|---|---|---|
| factor: | 4.58 | 3.68 | 3.33 | std. deviation |
| cello 1 | −0.036 | −0.032 | 0.337 | 0.011 |
| cello 2 | 0.182 | −0.158 | 0.153 | 0.009 |
| cello 3 | 0.087 | 0.291 | 0.006 | 0.013 |
| cello 4 | −0.056 | 0.108 | −0.084 | 0.008 |
| cello 5 | 0.301 | −0.061 | −0.175 | 0.010 |
| cello 6 | −0.132 | 0.059 | −0.068 | 0.011 |
| cello 7 | −0.174 | −0.123 | −0.073 | 0.013 |
| cello 8 | −0.105 | −0.203 | −0.116 | 0.008 |
| cello 9 | −0.070 | 0.116 | 0.026 | 0.010 |

TABLE 4
coordinates of the A strings of the cellos

| importance | coordinate 1 | coordinate 2 | coordinate 3 | |
|---|---|---|---|---|
| factor: | 3.31 | 2.71 | 2.40 | std. deviation |
| cello 1 | 0.131 | −0.116 | 0.308 | 0.018 |
| cello 2 | −0.035 | 0.155 | 0.100 | 0.011 |
| cello 3 | −0.035 | 0.116 | 0.079 | 0.010 |
| cello 4 | −0.239 | −0.016 | 0.047 | 0.009 |
| cello 5 | 0.017 | 0.140 | −0.234 | 0.012 |
| cello 6 | −0.099 | 0.131 | −0.005 | 0.007 |
| cello 7 | 0.149 | −0.125 | −0.077 | 0.019 |
| cello 8 | −0.147 | −0.309 | −0.122 | 0.012 |
| cello 9 | 0.259 | 0.018 | −0.096 | 0.011 |

The method for determining the timbre of an instrument capable of producing a tone with a sufficiently long stationary part, in the case where the harmonic vector space basis for this instrument type has already been established by the method described above, comprises the following steps:
a) selection of musical instrument and of at least one tone to be analyzed, and optionally playing style, if the analysis of piano playing, forte playing, or any other repeatable playing style is desired,
b) playing the tones selected in step a) with the instrument and detecting the sound signals by the measurement setup described above in a single time window of at least half a tenth of a second, preferably at least one tenth of a second, more preferably at least one second, wherein the playing of the selected tones can be repeated, preferably five times,
c) the initial (transient) and final (release) parts of the sound are removed from the instrument sound/signal recorded in step b),
d) Fourier transformation is performed, preferably with a window function that reduces the broadening of the spectral peaks due to the finite time window of the signal,
e) restriction to power, i.e., to the square of the absolute value of the amplitude,
f) determination of the fundamental frequency and the frequencies of the harmonics,
g) integration of the power in the frequency interval around each harmonic that corresponds to the width of the harmonic,
h) formation of a harmonic vector by frequency or amplitude weighting or ranking of the integrated harmonic powers, preferably by logarithms of the integrated harmonic powers, and
i) projecting the harmonic vector formed in the previous step onto the predefined harmonic vector space basis.

Thus, the procedure for evaluating the condition of the instruments based on the determined coordinates includes an analysis of the timbre, as described above, and a comparison of the coordinates.

1. A measurement system for precise quantification of timbre of musical instruments, said measurement system comprising a 2D assembly of microphones, preferably at least 5 microphones of same type, mounted on one or more stands, and an acquisition system for acquiring microphone signals, wherein the 2D assembly is the stand or a frame having a shape of a rectangle or other planar or spherical figure, and wherein the microphones are arranged as a field inside or along the perimeter of said figure.

2. The measurement system according to claim 1, wherein said microphones are arranged in at least two points and/or orientations that are the same and/or different, for example vertical and horizontal or along two diagonals, two parallel verticals or two parallel horizontals.

3. The measurement system according to claim 1, wherein the microphone field is shaped as a cross or letter X.

4. The measurement system according to claim 1, wherein the system is arranged for measurements in a free-sound field and comprises at least 5, preferably 10 or more microphones arranged at a distance from 1 to 10 m from the musical instrument, wherein the distances between the microphones are from 1 cm to 30 cm, preferably from 5 to 25 cm, usually 7 cm.

5. The measurement system according to claim 1, wherein the system is arranged for measurements in a diffuse sound field and comprises at least 5, preferably 10 or more microphones arranged arbitrarily in space to allow measurement at distances comparable to the largest relevant sound wavelength, which allows for local averaging of acquired signals in agreement with statistical requirements for diffuse sound fields.

6. The measurement system according to claim 1, wherein the system for acquisition microphone signals is configured in agreement with requirements of microphones, usually including enhancement, filtration, and analogue-to-digital conversion.

7. The measurement system according to claim 1, wherein the system further comprises a memory and/or a computer for storing acquired signals in a digital format on a storage medium and for computer analysis and processing.

8. A method for determination of timbre of a musical instrument suitable to produce a tone with a sufficiently long stationary part, wherein the method comprises the following steps:
a) selection of a musical instrument(s) and tones to be analyzed, and optionally playing style, if analysis of piano playing, forte playing, or any other repeatable playing style is desired,
b) playing the tones selected in step a) with the selected instrument and detecting sound signals of played instrument by the measurement setup according to any of the preceding claims or a sound signal generated directly on an electric/electronic instrument or an acoustic instrument equipped with a system for sound acquisition, in a single time window of at least half a tenth of a second, preferably at least one tenth of a second, most preferably at least one second, wherein the playing of the selected tones can be repeated, preferably five times,
c) removing initial, i.e., transient, and final, i.e., release, parts of the sound from the instrument sound/signal recorded in step b),
d) performing Fourier transform, preferably with a window function that reduces the broadening of the spectral peaks due to the finite time window of the signal,
e) restriction to power, i.e., to the square of the absolute value of the amplitude,
f) determination of a fundamental frequency and frequencies of harmonics,
g) integration of the power in the frequency interval around each harmonic that corresponds to the width of the harmonic,
h) formation of a harmonic vector by frequency or amplitude weighting or ranking of the integrated harmonic powers, preferably by logarithms of the integrated harmonic powers, and
i) PCA or SVD analysis of the vectors formed in the previous step,
wherein the result of steps h) and i) is a vector basis that most efficiently describes the statistical variations of the vectors and is hierarchically order by importance, wherein in development of said vectors in the vector basis a first vector is given the largest weight, followed by a second basis vector, which is given a second largest weight, smaller factor, and so on, wherein coordinates of the selected musical instrument are projections of its harmonic vector onto said basis vectors.

9. The method for determination of timbre of musical instruments according to claim 8, wherein in step a) at least three tones or measurement points are selected, possibly more depending on the type of analysed instrument, preferably in different octaves or in the lower part of the range, the middle part of the range, and the upper part of the range.

10. The method for determination of timbre of musical instruments according to claim 8, wherein:
sound samples of the most stationary parts of the instrument sounds are analyzed, i.e. all microphone signals x(tⱼ) individually,
fast Fourier transform (FFT) of the signals is performed, with one of the normalized standard time window functions w(tⱼ), e.g. Blackmann-Harris, x(fₖ)=FFT[x(tⱼ)w(tⱼ)],
the spectral power is calculated, i.e. the square of the absolute value of the FFT transform, |x(fₖ)|²,
power peaks with sufficient prominence and a prescribed minimum spacing are located using a peak-finding method, a histogram of the frequency differences of adjacent peaks is then constructed and the exact position of its maximum is determined by interpolation, where the maximum corresponds to the fundamental frequency of the sound and its multiples correspond to the harmonics, which are then placed on the nearest points of the FFT grid,
the powers in a suitable frequency neighbourhood k around each harmonic i are summed to the total power of this harmonic Pᵢ=Σₖ|x(fᵢ₊ₖ)|², where the width of the summation neighbourhood depends on the width of the harmonics, the preferable relative width of the summation neighbourhood being 0.02,
vectors P with the powers Pⁱ of the harmonics as the components, which exist for each microphone channel, are arithmetically averaged over all channels to obtain a single spectral vector P̅ for each measurement,
the harmonic power spectra thus obtained are logarithmized, hᵢ=log₁₀P̅ᵢ̅, where the logarithms hᵢ represent the loudness of the harmonics and form the components of a multidimensional »harmonic« vector h whose dimensionality depends on the chosen number of harmonics,
the harmonic vectors h are determined for each instrument, with each measurement repeated several times, resulting in the corresponding number of harmonic vectors h^{j},
the harmonic vectors of all instruments are stacked as columns in the matrix Aᵢⱼ, which is decomposed with the SVD (singular value decomposition),
$$A = U S {V}^{T} , {A}_{ij} = {\sum }_{k} {U}_{ik} {S}_{k} {V}_{kj}^{T}$$
where U is a square matrix of the size of the harmonic vector, S=diag(Sₖ) is a diagonal matrix of the same size with nonnegative values Sₖ ordered from largest to smallest, and V^{T} is a wide matrix of the same height and with width equal to the number of harmonic vectors,
the SVD decomposition finds mutually orthogonal linear combinations in the space of harmonic vectors h^{j}—the harmonic basis vectors, i.e., the timbre »factors«, where column k of the Uᵢₖ matrix is the harmonic representation of the k-th timbre factor, Sₖ is its importance factor, columns of the matrix Vₖⱼ^{T} are representations of harmonic vectors j in the basis of the timbre factors, and rows are representations of these factors in the canonical basis of the harmonic vectors of the collection, the rows of the wide V^{T} matrix are orthonormal, while the columns are orthogonal only as completely as possible, but not completely orthogonal, with norms generally less than 1,
a sample j of the collection is written as
$${h}_{i}^{j} = {A}_{ij} = {U}_{i 0} {S}_{0} {V}_{0 j}^{T} + {U}_{i 1} {S}_{1} {V}_{1 j}^{T} + {U}_{i 2} {S}_{2} {V}_{2 j}^{T} + {U}_{i 3} {S}_{3} {V}_{3 j}^{T} +$$
the timbre coordinates assigned to a sample of the collection are the components of the corresponding column of the V^{T} matrix, for example, the first four coordinates of the j-th sample are the numbers
$${V}_{0 j}^{T} , {V}_{1 j}^{T} , {V}_{2 j}^{T} and {V}_{3 j}^{T} ,$$
where the zeroth coordinate represents loudness only,
the timbre coordinates of the j-th sample are thus
$$( {c}_{1}^{j} , {c}_{2}^{j} , {c}_{3}^{j} , … ) = ( {V}_{1 j}^{T} , {V}_{2 j}^{T} , {V}_{3 j}^{T} , … ) ,$$
a general harmonic vector g is projected onto the representations of the basis vectors:
$${c}^{j} = \frac{1}{{S}_{j}} {\sum }_{i} {U}_{ij} {g}_{i}$$
the timbre coordinates of any sample with the harmonic vector g, which is not necessarily part of the collection defining the basis vectors of the timbre space, are thus
$$( {c}_{1} , {c}_{2} , {c}_{3} , … ) = ( \frac{1}{{S}_{1}} {\sum }_{i} {U}_{i 1} {g}_{i} , \frac{1}{{S}_{2}} {\sum }_{i} {U}_{i 2} {g}_{i} , \frac{1}{{S}_{3}} {\sum }_{i} {U}_{i 3} {g}_{i} , … ) .$$

11. The method for determination of timbre of musical instruments according to claim 9, wherein the method is used for analysis of musical instruments with sustained, driven sound, such as strings, brass, woodwinds.

12. The method for determination of timbre of musical instruments according to claim 9, wherein the method is performed in a free sound field or in a diffuse sound environment, such as a reverberation chamber, or in a sufficiently large room, usually a concert hall or a similar venue.

13. A method for determination of timbre of a musical instrument suitable to produce a tone with a sufficiently long stationary part, wherein for the selected musical instrument a database of harmonic vector space using the method according to claim 8 is already prepared, wherein the method comprises the following steps:
a) selection of musical instrument and of at least one tone to be analyzed, and optionally playing style, if the analysis of piano playing, forte playing, or any other repeatable playing style is desired,
b) playing the tones selected in step a) with the instrument and detecting the sound signals by the measurement setup described above in a single time window of at least half a tenth of a second, preferably at least one tenth of a second, most preferably at least one second, wherein the playing of the selected tones can be repeated, preferably five times,
c) removing the initial, i.e., transient, and final, i.e., release, parts of the sound from the instrument sound/signal recorded in step b),
d) performing Fourier transform, preferably with a window function that reduces the broadening of the spectral peaks due to the finite time window of the signal,
e) restriction to power, i.e., to the square of the absolute value of the amplitude,
f) determination of the fundamental frequency and the frequencies of the harmonics,
g) integration of the power in the frequency interval around each harmonic that corresponds to the width of the harmonic,
h) formation of a harmonic vector by frequency or amplitude weighting or ranking of the integrated harmonic powers, preferably by logarithms of the integrated harmonic powers, and
i) projecting the obtained harmonic vector g onto the predefined harmonic vector space basis:
$${c}^{j} = \frac{1}{{s}_{j}} {\sum }_{i} {U}_{i j} {g}_{i}$$
the timbre coordinates of any sample with the harmonic vector g, which is not necessarily part of the collection defining the basis vectors of the timbre space, being
$$( {c}_{1} , {c}_{2} , {c}_{3} , … ) = ( \frac{1}{{S}_{1}} {\sum }_{i} {U}_{i 1} {g}_{i} , \frac{1}{{S}_{2}} {\sum }_{i} {U}_{i 2} {g}_{i} , \frac{1}{{S}_{3}} {\sum }_{i} {U}_{i 3} {g}_{i} , … ) .$$

14. The method for determination of timbre of musical instruments with the measurement system according to claim 9, wherein the method is performed with a computer and/or a computer program programmed to execute steps of the method.

15. Use of the measurement system and/or the method for determination of timbre of musical instruments according to claim 1 in marking of musical instruments, in comparison of musical instruments, in musical production, in retail and manufacture of musical instruments, in analysis of damaged or counterfeit musical instruments, for tracking sound alteration of a particular musical instrument, in repair and fine-tuning of musical instruments and/or in sound design.

16. A method of evaluation of state of musical instruments, comprising the step of performing the method according to claim 8 and comparison of coordinates of musical instruments.
